(19) United States
(12) Patent Application Publication
(10) Pub. No.: US 2011/0143315 A1
(43) Pub. Date: Jun. 16, 2011

(54) ADAPTER FOR TRANSMITTING A TORQUE TO THE MOUNTING PART OF A DENTAL IMPLANT

(75) Inventors: Daniel GUENTER, Basel (CH); Guillaume Bugnard, Basel (CH); Nicolai Bernhard, Winterthur (CH); Jost Lussi, Basel (CH); Stephane Courvoisier, Basel (CH)

(73) Assignee: Straumann Holding AG, Basel (CH)

(21) Appl. No.: 12/842,527

(22) Filed: Jul. 23, 2010

(30) Foreign Application Priority Data
Jul. 27, 2009 (EP) EP 09 009 673.6

(51) Int. Cl. A61C 3/00

(52) U.S. Cl. 433/147

(57) ABSTRACT

Adapter (10, 110) for transmitting a torque from a screwing instrument to a mounting part of a dental implant, in particular for screwing the dental implant into a bone or for screwing the mounting part into an anchoring part. The adapter (10, 110) has a head portion (20, 120), which can engage with the screwing instrument, and a receiving portion (40, 140). The receiving portion (40, 140) can be connected releasably to the mounting part of the dental implant. The adapter (10, 110) has at least one zone of weakness (32, 50, 132) and, above a predetermined torque T_{deform}, deforms in the area of the zone of weakness (32, 50, 132).

### FIELD OF THE INVENTION

The present invention relates to an adapter for transmitting a torque from a screwing instrument to the mounting part of a dental.

### BACKGROUND

The use of dental implants as artificial replacements for tooth roots has become firmly established in recent years. There are various forms of dental implants, the most popular being screw-shaped implants. Dental implants are typically made of titanium or of various ceramics.

Screw-shaped dental implants are usually composed of an anchoring part for anchoring the implant in the bone, and of a mounting part on which a superstructure, for example a crown, can be secured. If anchoring part and mounting part are designed as a single structural part, this is referred to as a one-piece implant. Alternatively, two-piece implants are also used in which the anchoring part and the mounting part are designed as two separate structural parts.

To fix a screw-shaped dental implant in the bone, the implant is screwed into a matching drilled hole. The superstructure (crown) is then secured on the mounting part of the implant.

To allow a dental implant to be screwed into the bone, conventional implants usually have an inner thread in the area of the anchoring part and/or of the mounting part for the purpose of attaching a screw-in adapter, on which a screwing instrument can be secured for transmitting a torque to the implant. Such screw-in adapters are known from EP 1 038 506, WO 2008/071368 or EP 0 811 358, for example. Alternatively, a suitably shaped adapter can also be mounted on the mounting part and connected to the latter by means of a form fit, for example. To permit screwing in, a torque is applied, for example with the aid of a ratchet, to the adapter mounted on the implant or anchored in the inner thread of the implant. The adapter is then released again from the dental implant.

During the screwing-in procedure, there is a risk of too great a torque being transmitted to the dental implant and, consequently, of excessive force being applied to the mounting part or to the bone, which can lead to bone resorption. Particularly when an adapter is used that is mounted on the implant, there is a risk of traces from the adapter being left behind on the implant, or of the implant being damaged. Any traces of the adapter that are left behind on the mounting part are not only unattractive, they can also result in reduced adherence of the superstructure to the mounting part. The implant can be damaged internally, for example by formation of microfissures, and also externally, for example by partial destruction of an osseointegration surface.

Moreover, an excessive torque can also damage the bone tissue around the drilled hole into which the dental implant is to be screwed. Such damage to the bone tissue can result in reduced osseointegration and, consequently, impaired anchoring of the implant in the bone.

Damage to the dental implant or to the bone tissue can be avoided by transmitting the torque to the adapter using a so-called torque wrench, with which a maximum transmissible torque can be set. To do so, an adapter is mounted on the implant or anchored in the inner thread of the implant, after which a torque wrench acting as a ratchet is used to apply a torque to the adapter connected to the mounting part of the implant. To guarantee the integrity of implant and bone tissue, it is essential to use a specific torque wrench whose maximum torque is adapted to the implant being used.

Torque wrenches are relatively expensive. It is also necessary for the user to adapt the maximum torque according to the material of the implant being used. Torque wrenches are also dependent on direction of rotation, i.e. the torque is not limited if they are mounted or used the wrong way round.

### SUMMARY OF THE INVENTION

According to one or more embodiments of the present invention there is provided an adapter which is easy to produce and easy to handle and which transmits a torque to the mounting part of a dental implant and preferably by means of which it is possible, independently of the choice of screwing instrument and of the direction of rotation, to ensure that the implant or the surrounding bone tissue is not damaged.

The present invention relates to an adapter for transmitting a torque from a screwing instrument to a mounting part of a dental implant. The transmission of the torque to the mounting part serves either to screw the screw-shaped anchoring part of the dental implant into a bone or to screw the mounting part into an anchoring part. Along a centrally disposed longitudinal axis, the adapter has a head portion and, connected rigidly to the latter, a receiving portion. The head portion is designed in such a way that it can engage with the screwing instrument for transmitting the torque. The receiving portion has a jacket-like wall which delimits a recess in the form of a blind hole for receiving the mounting part of the dental implant and via which the receiving portion can be releasably connected to the mounting part of the dental implant by a form fit. The adapter according to the invention is characterized in that it has at least one zone of weakness, and in that it deforms, above a predetermined torque T_{deform}, in the area of the zone of weakness. The adapter preferably deforms plastically and/or elastically above the predetermined torque T_{deform}.

The adapter according to the invention is designed in such a way that it can be mounted on the mounting part of a dental implant and can be easily removed from the mounting part after the dental implant has been screwed into a bone or after the mounting part has been screwed into an anchoring part. The adapter is suitable for one-piece dental implants and also for two-piece dental implants, and it can in particular be used to screw a one-piece or two-piece dental implant into the bone.

The head portion of the adapter is designed in such a way that a screwing instrument can be used to transmit a torque to the adapter and thus to the mounting part of the dental implant connected to said adapter. A ratchet, for example, can be used as the screwing instrument. Alternatively, a screw wrench or a torque wrench can also be used to transmit a torque to the adapter. A torque wrench indicates the nominal torque and thus permits an additional check by the user, while the adapter according to the present invention ensures torque limitation.

The at least one zone of weakness of the adapter according to the invention has the effect that the latter deforms, in particular plastically and/or elastically, above the predetermined torque T_{deform}. The adapter is stable below the predetermined torque. It is only above the predetermined torque T_{deform} that the adapter begins to deform. In this way, the user recognizes that too great a torque is being applied and that the torque transmission must be stopped. The zone of weakness is preferably designed in such a way that the adapter breaks in this area in the event of (continued) excessive torque transmission. This effectively prevents the dental implant and/or the surrounding bone tissue from being damaged when the dental implant is being screwed in.

A deformation, according to the invention, of the adapter also takes place in particular when the adapter breaks in the area of the zone of weakness above the predetermined torque T_{deform}, which corresponds to a particularly preferred embodiment of the invention.

In a preferred embodiment, the adapter is made of metal or of a metal alloy, in particular of stainless steel. Thus, for example, the adapter can be made of 1.4441 steel (X2CrNiMo18-15-3; contains 17.0 to 19.0 percent by weight of chromium, 13.0 to 15.0 percent by weight of nickel, 2.7 to 3.0 percent by weight of molybdenum, 1.4 to 2.0 percent by weight of manganese, and a maximum 0.03 percent by weight of carbon, a maximum 1.0 percent by weight of silicon, a maximum 0.025 percent by weight of phosphorus, a maximum 0.06 percent by weight of sulfur, a maximum 0.1 percent by weight of copper and a maximum 0.1 percent by weight of nitrogen). These materials are particularly suitable since, on the one hand, they guarantee a good stability of the adapter below the torque T_{deform} and, on the other hand, a clean break occurs when T_{deform} is exceeded. This avoids the formation of (metal) splinters that could cause injuries or irritation in the oral cavity and particularly in the area of the implantation site.

In the case of an adapter made of metal or of a metal alloy, it is particularly preferable that the inner face of the receiving portion is at least partially coated with a material that does not leave traces behind on the implant surface. This is of great advantage particularly in ceramic implants. Therefore, a ceramic coating or a coating of DLC (diamond-like carbon) is particularly preferred. This coating preferably covers at least those areas of the inner face of the receiving portion that are in direct contact with the dental implant during the screwing-in procedure. It is particularly preferable that the entire inner face of the receiving portion of the adapter is coated with DLC or with a ceramic.

Alternatively, the adapter can also be made at least partially of a ceramic or brittle material, such that it breaks in the area of the zone of weakness when too great a torque is transmitted.

The at least one zone of weakness of the adapter can be of any desired size. Such a zone of weakness can be designed, for example, as a slit or groove in the jacket-like wall of the receiving portion.

Alternatively, it is also possible for the adapter according to the invention to be designed with a zone of weakness in an area between the head portion and the receiving portion. In this case, if the predetermined torque T_{deform} is exceeded, this preferably causes the adapter to break in this area.

The use of an adapter according to the invention for transmitting a torque from a screwing instrument to the mounting part of a dental implant makes it possible, during the screwing-in procedure, to avoid damage to the implant or to surrounding bone tissue, independently of the choice of screwing instrument. At the same time, however, it is ensured that an adequate torque is transmitted to the mounting part such that the dental implant is anchored sufficiently firmly in the bone or the mounting part is anchored sufficiently firmly in the anchoring part. Moreover, the adapter functions independently of the direction of rotation, in other words it can be used for both directions of rotation, in contrast to a torque wrench, and ensures torque limitation.

When using the adapter according to the invention, it is possible to do without a torque wrench. During the screwing-in procedure, the user can immediately tell from the deformation of the adapter that too great a torque is being applied and can thus avoid damage to the dental implant or the bone tissue. Moreover, the zone of weakness is preferably designed in such a way that, if an excessive torque continues to be transmitted, the adapter breaks and the torque transmission is in this way stopped. However, it is entirely conceivable that, in addition to the adapter according to the invention, a torque wrench is employed which, during use, additionally indicates the nominal torque to the user.

In a preferred embodiment, the adapter additionally has a neck portion that connects the head portion to the receiving portion. This neck portion is preferably made narrower than the head portion and receiving portion.

In another preferred embodiment, the at least one zone of weakness of the adapter extends at least partially in the radial direction around the adapter. Such a radial zone of weakness preferably completely surrounds the adapter. Alternatively or in addition to such a radially extending zone of weakness, it is also possible for the zone of weakness to extend substantially parallel to the longitudinal axis of the adapter.

In a particularly preferred embodiment, the at least one zone of weakness is designed as a groove in the neck portion of the adapter. Such an arrangement of the zone of weakness is especially suitable for “automatically” stopping the transmission of too great a torque: the adapter breaks at this location as soon as a predetermined maximum torque is exceeded, and further torque transmission is prevented. The neck portion thus has a kind of “predetermined break”, by virtue of which it is possible to avoid the transmission of too great a torque.

During the screwing-in of the mounting part, a torque is transmitted to the adapter according to the invention by means of a suitable instrument. If the instrument is not held completely straight by the user for example, it can happen that, in addition to the radially acting torque, a substantially axial bending force is also applied to the head portion of the adapter. Particularly in those embodiments which have a narrower neck portion between head portion and receiving portion, such a bending force can have the effect that the adapter bends relative to its longitudinal axis, i.e. is set at an angle, and the adapter breaks in the area of the zone of weakness at a torque lower than the one actually intended. In order to avoid undesired bending of the adapter, the latter can therefore have an additional reinforcement in the area of the zone of weakness.

Such a reinforcement preferably completely surrounds a zone of weakness extending in the circumferential direction, i.e. radially, in the neck area and thus prevents the adapter from being angled in this area. Possible embodiments of such a reinforcement are, for example, a ring, e.g. an O-ring, or a bridging piece which, in addition to surrounding the zone of weakness, also surrounds an area of the neck portion axially adjacent to the zone of weakness.

The reinforcement is preferably produced from a hard plastic or a metal or a metal alloy, e.g. titanium or steel, in particular stainless steel. These materials permit optimal stabilization of the adapter in the axial direction and can be easily brought to the desired shape.

The use of a bridging piece, which not only surrounds the zone of weakness but also a wider part of the neck portion adjacent thereto, has the additional advantage that it can also hold the parts together, after the adapter has broken, and thus prevents broken fragments from falling. To further improve the connection between bridging piece and neck portion, the latter can also have one or more depressions in which the bridging piece can engage. Such depressions preferably extend in the circumferential direction.

In a preferred embodiment, the at least one zone of weakness is designed as a groove in the jacket-like wall of the receiving portion. Alternatively or in addition, the at least one zone of weakness can also be designed as a slit on the inner face or outer face of the jacket-like wall of the receiving portion. A zone of weakness designed as a groove or slit widens when the predetermined torque T_{deform} is exceeded, particularly in an end area of the slit. It is also conceivable to combine several grooves and/or slits with one another, in particular to combine a zone of weakness extending radially around the adapter with a zone of weakness extending parallel to the longitudinal axis of the adapter and in the form of a groove or a slit.

Suitable values for T_{deform} are in principle dependent on the material, shape and diameter of the mounting part and of the dental implant that is to be screwed in. A person skilled in the art of dental implantology is easily able to determine these values without any great effort in terms of experimentation.

In a preferred embodiment, T_{deform} is greater than 35 Ncm, preferably greater than 80 Ncm, in particular greater than 90 Ncm. The choice of a suitable minimum value of T_{deform} ensures that the dental implant is anchored sufficiently firmly in the bone, or the mounting part is anchored sufficiently firmly in the anchoring part, during the screwing-in procedure.

In a preferred embodiment, T_{deform} is less than 150 Ncm, preferably less than 130 Ncm, in particular less than 110 Ncm. The choice of a suitable maximum torque guarantees that the dental implant and the surrounding bone tissue are not damaged during the screwing-in procedure.

In a preferred embodiment, the head portion has substantially the shape of a polygonal cylinder with several edges extending parallel to the longitudinal axis A, or other form-fit connections, e.g. Torx. In particular, the head portion has substantially the shape of a hexagonal or octagonal cylinder. Such a design of the head portion allows a screwing instrument such as a ratchet, a conventional screw wrench or a torque wrench to be connected to the head portion and allows a torque to be transmitted to the adapter. Alternatively, it is also possible that the head portion has an inner hexagon, inner octagon or another inner form-fit connection, e.g. an inner Torx, which can engage with a screwing instrument.

In a preferred embodiment of the adapter according to the invention, the recess in the form of a blind hole is substantially frustoconical and narrows toward the head area. Alternatively, the recess in the form of a blind hole can also have a substantially cylindrical design or the shape of a stepped cylinder. Such a shape is optimally adapted to the nowadays customary form of mounting parts of dental implants.

The recess in the form of a blind hole preferably has at least one stop surface for transmitting the torque from the adapter to the mounting part, each of the stop surfaces forming, with a corresponding mating surface of the mounting part, a connection that is secure against rotation up to at least the torque T_{deform}. Such a stop surface ensures that, during rotation of the adapter, the mounting part in the interior thereof is also rotated. If the predetermined torque T_{deform} is exceeded, this rotationally secure connection is preferably canceled in those embodiments in which the zone of weakness is arranged in the receiving portion of the adapter.

It is particularly preferable that the recess in the form of a blind hole in the receiving portion has several stop surfaces, in particular two, four or six stop surfaces. In the case of several stop surfaces, the torque to be transmitted is also transmitted to several corresponding mating surfaces of the mounting part of the implant, such that the force acting on the individual surfaces is smaller and there is therefore less risk of damage. In addition, it is also possible in this way to prevent the adapter from leaving traces behind on the implant surface, particularly by abrasion.

In a preferred embodiment, the adapter according to the invention is made of metal, for example of stainless steel, titanium or a titanium alloy, or of other biocompatible materials such as polymers, fiber-reinforced polymers or ceramics. The adapter can additionally be provided with a hard layer, e.g. titanium nitride, zirconium nitride or chromium nitride. These materials permit simple production and sterilization and ensure the biocompatibility of the adapter. It is particularly preferable for the adapter to be produced from stainless steel, for example from 1.4441 steel (X2CrNiMo18-15-3; contains 17.0 to 19.0 percent by weight of chromium, 13.0 to 15.0 percent by weight of nickel, 2.7 to 3.0 percent by weight of molybdenum, 1.4 to 2.0 percent by weight of manganese, and a maximum 0.03 percent by weight of carbon, a maximum 1.0 percent by weight of silicon, a maximum 0.025 percent by weight of phosphorus, a maximum 0.06 percent by weight of sulfur, a maximum 0.1 percent by weight of copper and a maximum 0.1 percent by weight of nitrogen).

The adapter is preferably designed in one piece. Alternatively, however, it is also possible for the adapter according to the invention to be designed in two or more pieces. Thus, for example, it is possible for only the receiving portion to be made of a ceramic, while the head portion and neck portion are made of a metal. Alternatively, however, the receiving portion can also be coated with a ceramic or a similar material that does not leave traces behind on the implant surface, in particular visible traces caused by abrasion. The receiving portion is preferably produced from or coated with the same material as the mounting part of the dental implant to be received therein, in particular from the same ceramic, such that the adapter leaves no traces behind at all on the mounting part.

Particularly in the case of an adapter made of metal or of a metal alloy, it is preferable that the inner face of the receiving portion is at least partially coated with a material that does not leave traces behind on the implant surface. This is particularly important in the case of ceramic implants. A ceramic coating or a coating of DLC (diamond-like carbon) is therefore particularly preferred. This coating preferably covers at least those areas of the inner face of the receiving portion that are in direct contact with the dental implant during the screwing-in procedure. It is particularly preferable that the entire inner face of the receiving portion of the adapter is coated with DLC or a ceramic.

Furthermore, the present invention also relates to the use of the adapter according to the invention for transmitting a torque to a ceramic mounting part of a dental implant. The above-described advantages of the adapter are particularly apparent during this use: ceramic mounting parts and dental implants are generally white or very light in color, such that any traces of the adapter would be particularly easy to see. Moreover, ceramic implants break relatively easily under stress. However, the adapter according to the invention is also preferably suitable for screwing in dental implants made of metal. It can be used for one-piece dental implants and also for two-piece dental implants.

The dental implant connected to the adapter according to the invention is preferably screwed into a bone through a drill jig, particularly in combination with a drill sleeve. For this purpose, the adapter according to the invention is preferably designed in such a way that it is not only used through the drill jig and/or the drill sleeve but is at the same time guided by same. In this way, the orientation of the adapter connected to the implant can be determined through the drill jig and/or drill sleeve, such that the implant is screwed in precisely in the axis of the drilled hole.

In a preferred embodiment, the adapter according to the invention is also used to remove the dental implant from the package in which the latter is packed. For transport and storage, implants are usually packaged individually and in a sterile state and are removed from their package just shortly before being screwed into a bone. In order to avoid contamination of the sterile implant, the implant is preferably removed from the package with the aid of the adapter according to the invention. For this purpose, the mounting part of the dental implant is connected to the adapter still in the package, by means of the adapter being fitted onto the mounting part and then the implant being removed together with the adapter.

The adapter according to the invention preferably has a marking that indicates the position of the stop surface in the blind hole recess, such that the stop surface can be brought directly into contact with the corresponding mating surface of the mounting part of the dental implant. Such a marking can, for example, be a dot or line in a color different than the color of the adapter. Alternatively, the zone of weakness can also serve as a marking, particularly when the zone of weakness is designed as a slit. It is also conceivable that the dental implant or its package also has an orientation aid in relation to which the marking on the adapter can be aligned when the latter is mounted thereon. This orientation aid can be a differently colored dot or line. Alternatively, a projection or a depression in the package would also be conceivable. It is particularly preferable that the package has a projection in the longitudinal direction of the dental implant, which projection can engage with the zone of weakness of the adapter, designed as a slit or as a recess formed in the longitudinal direction of the adapter, and thus guides the adapter.

### BRIEF DESCRIPTION OF THE DRAWINGS

In the drawings:

FIG. 1 shows a schematic view of a first one-piece embodiment of an adapter according to the invention;

FIG. 2 shows an oblique view of the adapter from FIG. 1;

FIG. 3 shows a schematic view of a second one-piece embodiment of an adapter according to the invention;

FIG. 4 shows a schematic view of a third one-piece embodiment of an adapter according to the invention;

FIG. 5 shows a schematic view of a fourth one-piece embodiment of an adapter according to the invention;

FIG. 6 shows a schematic view of a fifth one-piece embodiment of an adapter according to the invention;

FIG. 7 shows a schematic view of a two-piece embodiment of an adapter according to the invention;

FIG. 8 shows the connection part of the adapter from FIG. 7;

FIG. 9 shows the securing part of the adapter from FIG. 7;

FIG. 10 shows a schematic view of a sixth one-piece embodiment of an adapter according to the invention;

FIG. 11 shows a perspective view of the adapter from FIG. 10;

FIG. 12 shows a perspective view of the crown area of a dental implant;

FIGS. 13a, 13b each show a respective part of two adapters according to the invention, with different reinforcements in the area of the neck portion.

### DETAILED DESCRIPTION

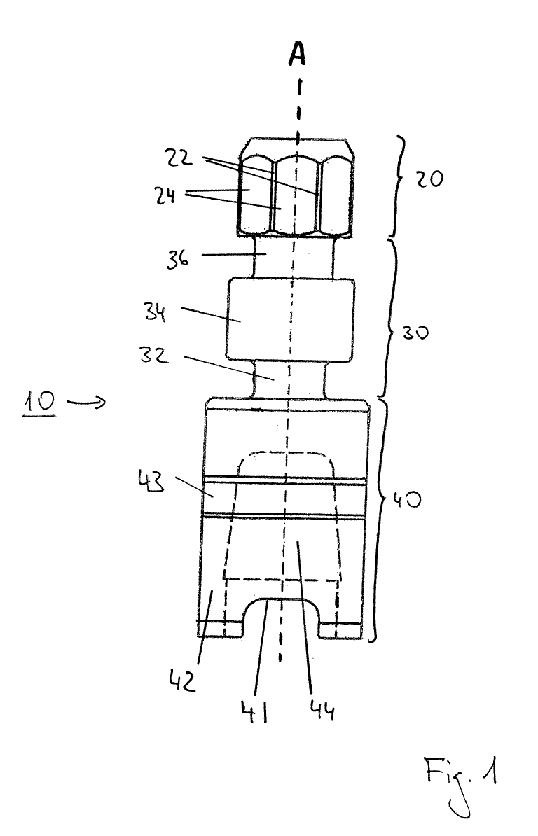

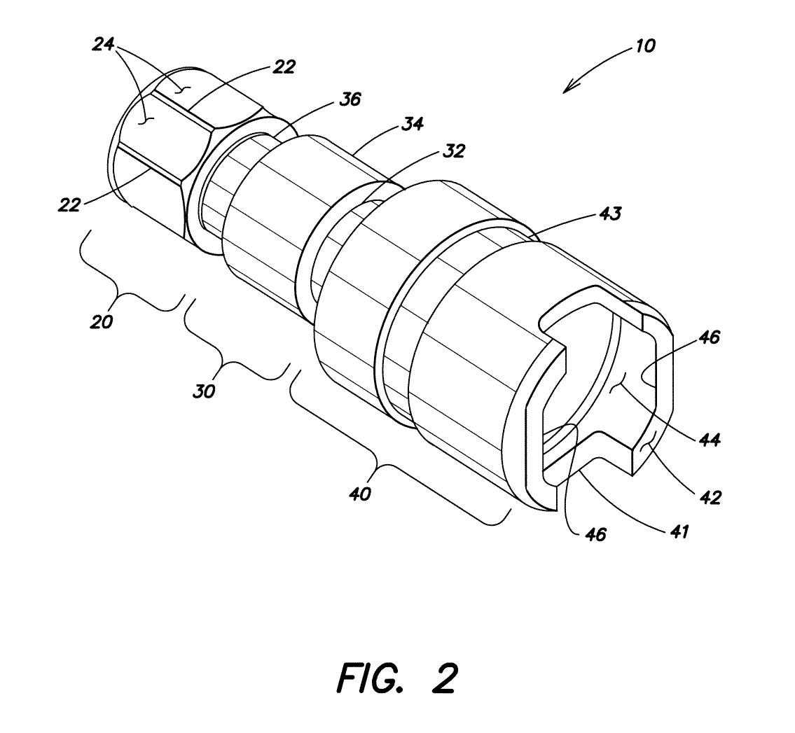

The adapter 10 shown in FIGS. 1 and 2, for transmitting a torque from a screwing instrument to the mounting part of a dental implant, is produced in one piece from stainless steel or from one of the other biocompatible materials mentioned above. Along a centrally disposed longitudinal axis A, the adapter 10 has a head portion 20, a neck portion 30 and a receiving portion 40, which are connected rigidly to one another.

The head portion 20 is designed as a hexagonal cylinder, in which six edges 22 extending parallel to the longitudinal axis delimit six cylinder surfaces 24 in the radial direction. By virtue of this shape, a screwing instrument with a corresponding hexagon socket can be mounted with a form fit onto the head portion 20 in order to permit torque transmission. Alternatively, other form-fit connections would also be conceivable, for example a Torx (screw head characterized by a 6-point star-shaped pattern) or an octagon.

The receiving portion 40 has a jacket-like wall 42, which delimits a recess 44 in the form of a blind hole for receiving the mounting part of the dental implant and via which the receiving portion 40 of the adapter 10 can be connected releasably to the mounting part of the dental implant by a form fit. In the jacket-like wall 42, the adapter shown has a radially encircling groove 43, and two recesses 41 arranged at the end directed away from the head area 20.

The recess 44 in the form of a blind hole is substantially frustoconical and narrows toward the head area 20. Alternatively, the recess 44 in the form of a blind hole could also be cylindrical or shaped as a stepped cylinder. The recess 44 in the form of a blind hole has two stop surfaces 46 for transmitting the torque from the adapter 10 to the mounting part of the dental implant, which stop surfaces 46 form, together with corresponding mating surfaces of the mounting part, a connection that is secure against rotation up to at least the torque T_{deform}.

The adapter 10 shown in FIGS. 1 and 2 has, in the area of the neck portion 30, a zone of weakness 32 which has substantially the shape of a circular cylinder and which is formed as a groove and extends around the adapter 10 in the radial direction. If, during the transmission of torque from the adapter 10 according to the invention to a dental implant, a predetermined torque T_{deform} is exceeded, the adapter 10 deforms plastically and/or elastically in the area of the zone of weakness 32. Moreover, in the neck portion 30, the adapter 10 has a wide area 34 substantially in the shape of a circular cylinder, and a narrower area likewise substantially in the shape of a circular cylinder, the wide area 34 being arranged between the zone of weakness 32 and the narrower area 36. The zone of weakness 32 is directed toward the receiving portion 40, and the narrower area 36 toward the head portion 20.

FIG. 3 shows another embodiment of a one-piece adapter 10 according to the invention, which differs from the one shown in FIGS. 1 and 2 in terms of the shape of the recess 44 in the form of a blind hole. This recess in FIG. 3 has substantially the shape of a circular cylinder and has a conical portion 48 at its end 47 directed toward the head portion 20. Moreover, the recess 44 in the form of a blind hole has a groove extending radially around the inner face of the jacket-like wall 42 of the receiving portion 40.

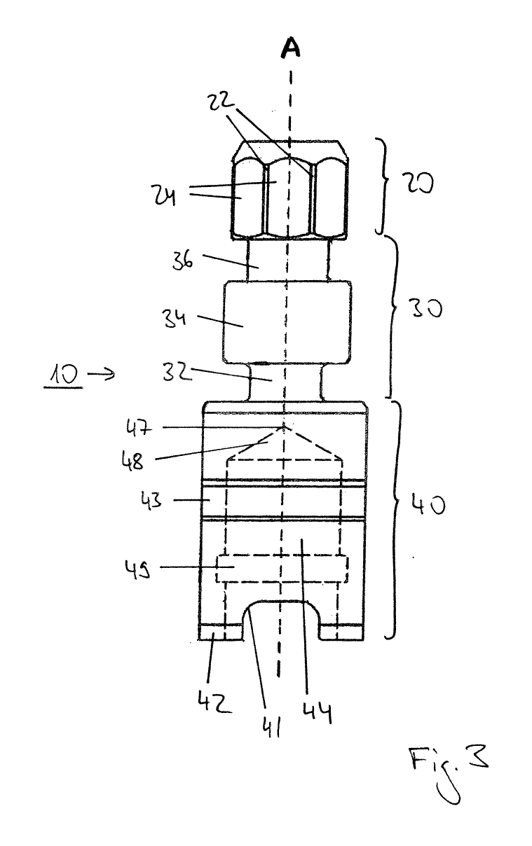

The one-piece adapter 10 according to the invention shown in FIG. 4 likewise comprises, along the centrally disposed longitudinal axis A, a head portion 20, a neck portion 30 and a receiving portion 40, which are connected rigidly to one another. In this third embodiment, however, the zone of weakness is designed as a slit 50 in the jacket-like wall 42 of the receiving portion. This slit 50 extends substantially parallel to the longitudinal axis A.

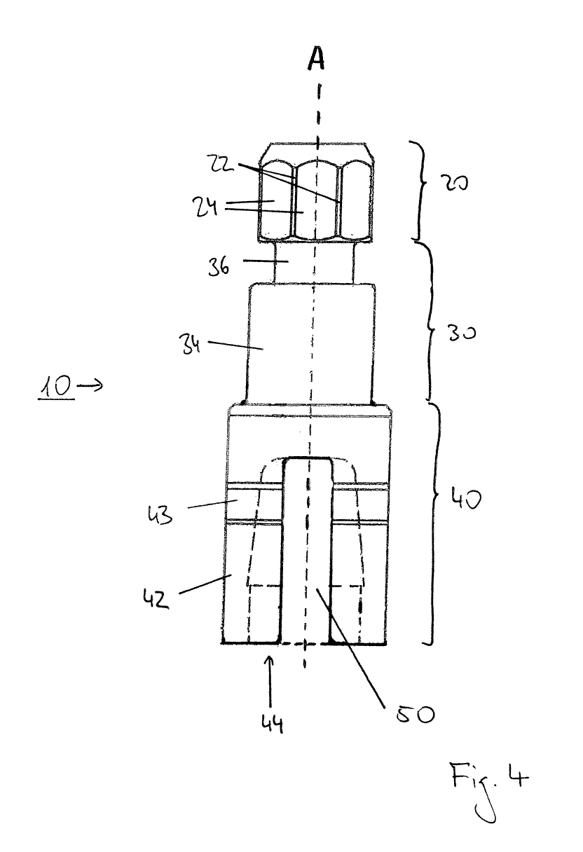

FIGS. 5 and 6 show two further embodiments of the one-piece adapter 10. These embodiments differ from the ones in FIGS. 1, 3 and 4 particularly in terms of the configuration of head portion 20, neck portion 30 and receiving portion 40. Thus, the (relative) height of the head portion 20, the configuration of the neck portion 30 and the shape of the jacket-like wall 42 of the receiving portion 40 vary between the different embodiments. For example, both adapters 10 shown in FIGS. 5 and 6 have a second wide area 35 in addition to the zone of weakness 32, the wide area 34 and the narrow area 36. Moreover, the zone of weakness 32 in the adapter 10 shown in FIG. 5 is narrower and less high than in the other embodiments. It has been found that this shape of the zone of weakness 32 shown in FIG. 5 permits an optimal concentration of the forces acting on the adapter 10 during the screwing-in procedure, with the result that, when too high a torque is used, the adapter breaks within a very narrow area in the zone of weakness 32 and as far as possible at right angles to the longitudinal axis A.

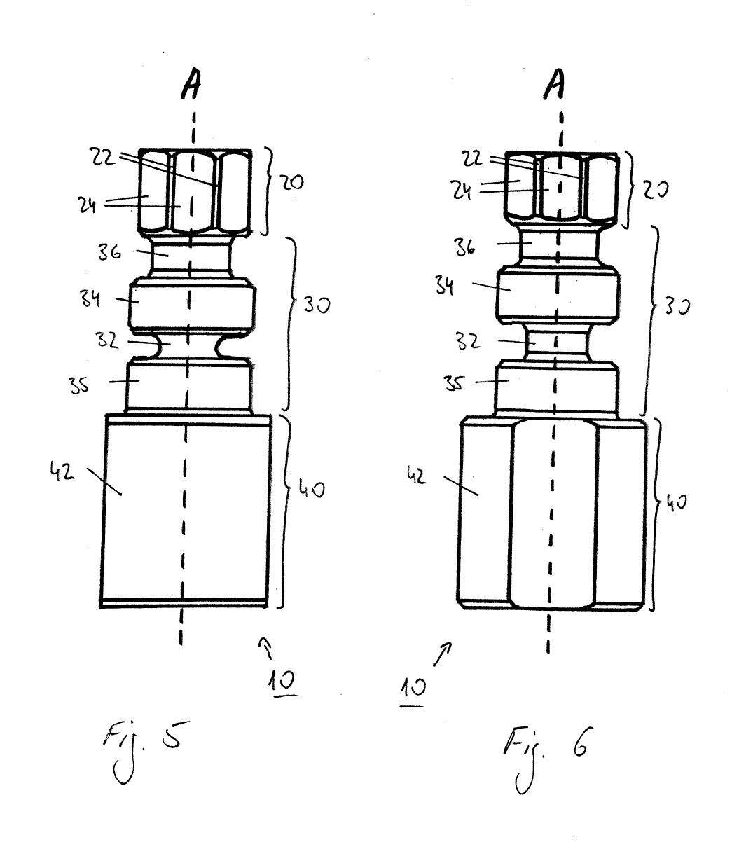

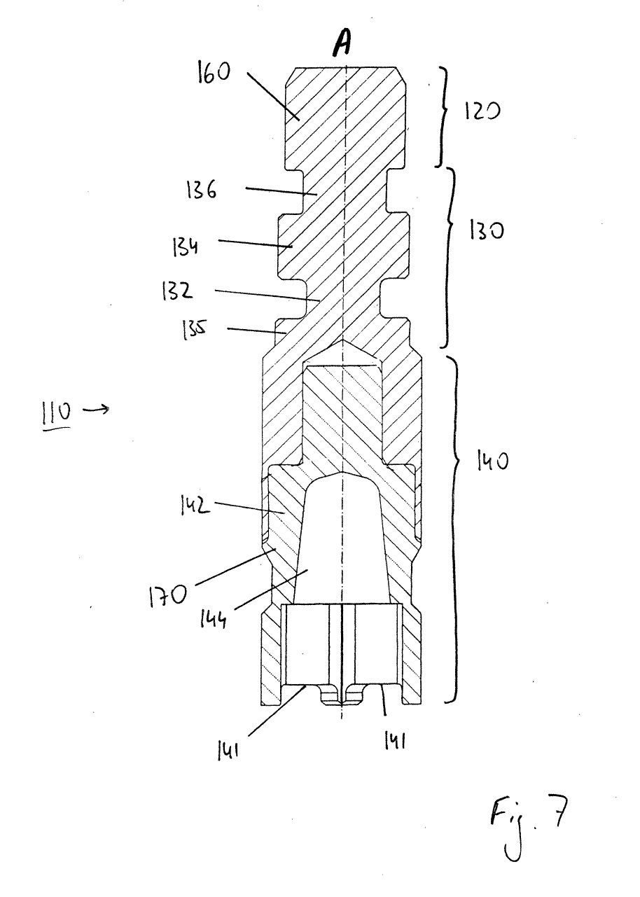

FIG. 7 shows a longitudinal section through a two-piece embodiment of an adapter 110 according to the invention. In the assembled state, the adapter again has a head portion 120, a neck portion 130 and a receiving portion 140 along a centrally disposed longitudinal axis A. The adapter 110 is assembled from a connection part 160, which is made of stainless steel and is also shown separately in longitudinal section in FIG. 8, and of a securing part 170, which is made of ceramic and which is also shown separately in longitudinal section in FIG. 9.

The head portion 120, the neck portion 130 with a zone of weakness 132, a first wide area 134, a second wide area 135 and a narrow area 136, and a part of the receiving portion 140 are assigned to the connection part 160. As can be seen in particular from FIG. 8, the connection part 160, at the end thereof directed away from the head portion 120, has a connection recess 164, which is designed to receive a securing projection 172 (see FIG. 9) of the securing part 170 and which is surrounded by a connecting jacket 162.

The securing part 170 forms the rest of the receiving portion 140 and has a recess 144 in the form of a blind hole for receiving the mounting part of the dental implant, which recess 144 is surrounded by a jacket-like wall 142. At the end directed away from the head area 120 in the assembled state, the securing part 170 has recesses 141. The securing part 170 also comprises the securing projection 172 which, for assembly of the adapter 110, is inserted into the connection recess 164 of the connection part 160 and can be connected fixedly thereto. To transmit a torque to the mounting part of a dental implant, the connection part 160 is first connected to the securing part 170, and the mounting part is then inserted into the recess 144 in the form of a blind hole. By virtue of the fact that the connection part 160 is produced from a ceramic, the adapter 110 according to the invention does not leave any traces behind on the mounting part of the implant.

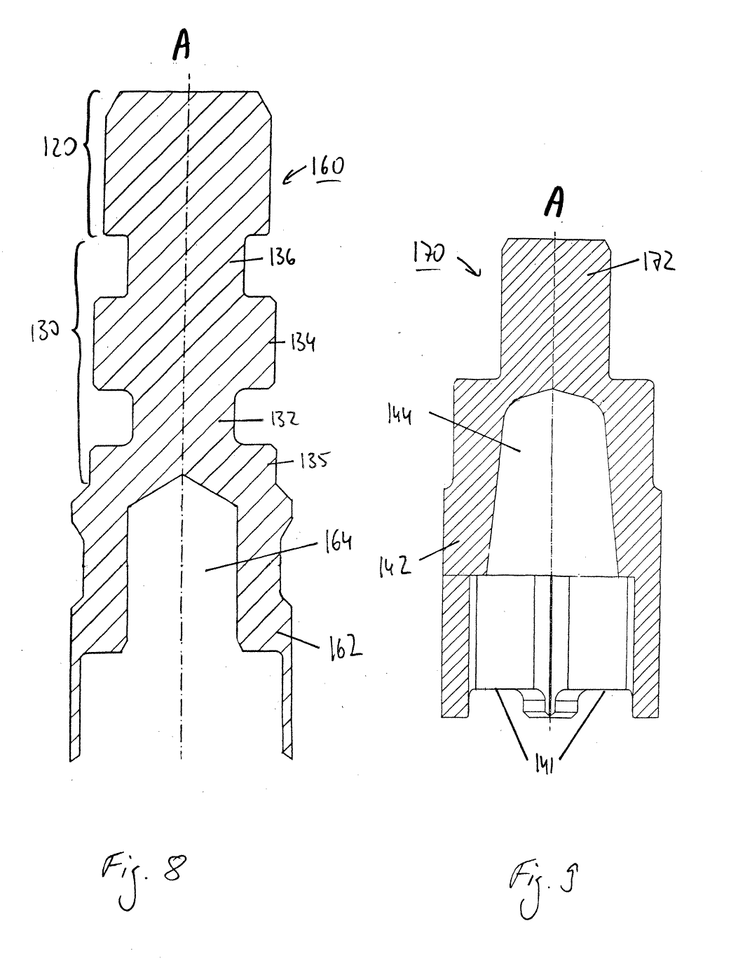

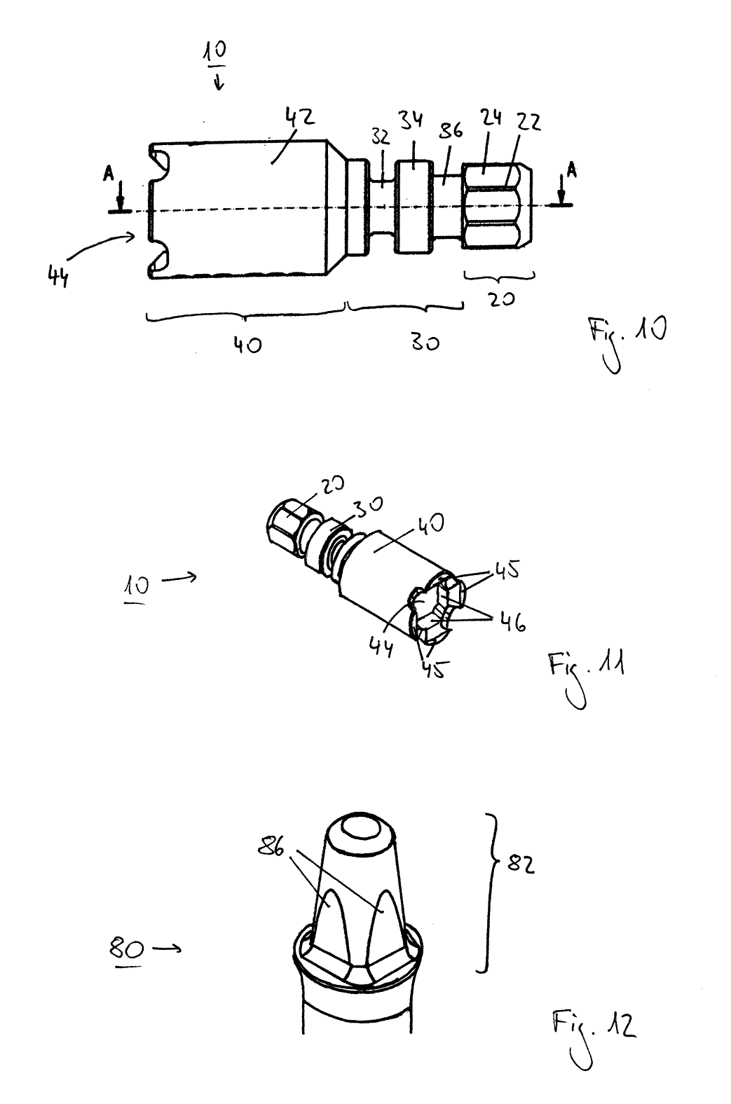

FIG. 10 shows another embodiment of a one-piece adapter 10 according to the invention, which differs from the one shown in FIGS. 1 to 3 in terms of the shape of the receiving portion 40. The receiving portion 40 has four areas arranged regularly in the circumferential direction, which areas have four stop surfaces (see FIG. 11) on their inner face, i.e. in the interior of the recess 44 formed as a blind hole. Alternatively, it would also be possible for the receiving portion 40 to have two or six stop surfaces for example.

The adapter 10 from FIG. 10 is shown in a perspective view in FIG. 11. The receiving portion 40 has four areas 45, which have four stop surfaces 46 on their inner faces, i.e. in the interior of the recess 44 in the form of a blind hole, and said stop surfaces 46 extend substantially parallel to the longitudinal axis of the adapter 10.

FIG. 12 shows the crown part of a dental implant 80, likewise in a perspective view (not true to scale in relation to the adapter 10 from FIG. 11). The dental implant 80 has a substantially frustoconical mounting part 82 with four mating surfaces 86 which are arranged at uniform intervals around the mounting part 82 and extend in the longitudinal direction of the dental implant 80.

With the aid of the four stop surfaces 46 of the adapter 10 from FIG. 11, a torque can be transmitted, for example, to the four corresponding mating surfaces 86 of the mounting part 82 of the dental implant 80 from FIG. 12. For this purpose, the mounting part 82 is inserted into the recess 44 in the form of a blind hole, such that the stop surfaces 46 can engage with the mating surfaces 86.

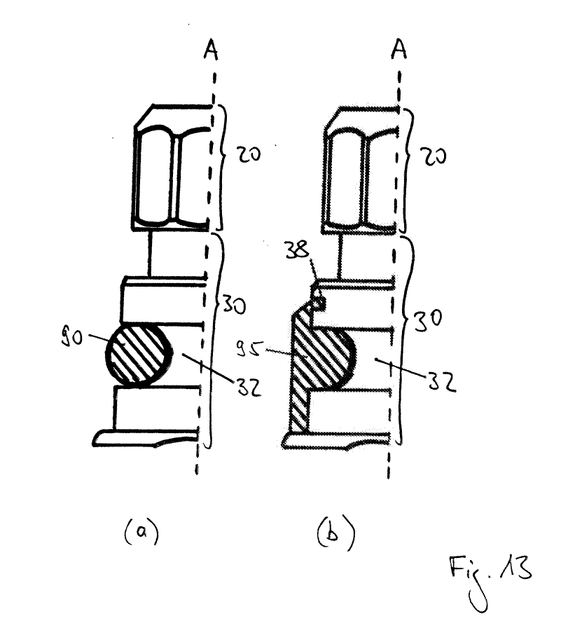

FIGS. 13a and 13b each show part of an adapter 10 according to the invention, for example of one of the embodiments shown in FIGS. 1 through 3, 5, 6 or 10, in which an additional reinforcement is arranged in the area of the zone of weakness 32 in the neck portion 30. This reinforcement can, for example, be in the form of an O-ring 90 (FIG. 13a) or of a bridging piece 95 (FIG. 13b). This reinforcement prevents the neck portion 30 from bending in the area of the zone of weakness 32 during the transmission of a torque. The O-ring 90 shown is made of a hard plastic and surrounds the zone of weakness 32 in the circumferential direction. Alternatively, a ring made of metal, for example of stainless steel, titanium or a titanium alloy, could also be used. The bridging piece 95 shown not only surrounds the zone of weakness 32 in the circumferential direction, but also a wider, axially adjacent part of the neck portion 30. To permit better connection of the bridging piece 95 to the neck portion 30, the latter additionally has a depression 38 which extends in the circumferential direction and in which the bridging piece 95 engages. The bridging piece 95 is preferably made of hard plastic, stainless steel or titanium.

1. An adapter for transmitting a torque from a screwing instrument to a mounting part of a dental implant, which adapter comprises, along a centrally disposed longitudinal axis A, a head portion and a receiving portion connected rigidly to the head portion, which head portion is designed to engage with the screwing instrument, and the receiving portion has a jacket-like wall which delimits a recess in the form of a blind hole for receiving the mounting part of the dental implant and via which the receiving portion can be releasably connected to the mounting part of the dental implant by a form fit,
the adapter has at least one zone of weakness, and, above a predetermined torque T_{deform}, the adapter deforms in the area of the zone of weakness.

2. The adapter as claimed in claim 1, wherein the adapter, above the predetermined torque T_{deform}, deforms plastically and/or elastically in the area of the zone of weakness.

3. The adapter as claimed in claim 1, wherein the adapter, above the predetermined torque T_{deform}, breaks in the area of the zone of weakness.

4. The adapter as claimed in claim 1, wherein the adapter has a neck portion that connects the head portion to the receiving portion.

5. The adapter as claimed in claim 1, wherein the at least one zone of weakness extends at least partially in the radial direction around the adapter.

6. The adapter as claimed in claim 5, wherein the at least one zone of weakness radially surrounds the adapter.

7. The adapter as claimed in claim 1, wherein the at least one zone of weakness extends substantially parallel to the longitudinal axis A of the adapter.

8. The adapter as claimed in claim 1, wherein the at least one zone of weakness is designed as a groove in the neck portion.

9. The adapter as claimed in claim 1, wherein the at least one zone of weakness is a groove on the inner face or outer face of the jacket-like wall of the receiving portion.

10. The adapter as claimed in claim 1, wherein the at least one zone of weakness is designed as a slit in the jacket-like wall of the receiving portion.

11. The adapter as claimed in claim 1, wherein T_{deform} is greater than 35 Ncm.

12. The adapter as claimed in claim 1, wherein T_{deform} is less than 150 Ncm.

13. The adapter as claimed in claim 1, wherein the head portion has substantially the shape of a polygonal cylinder with several edges extending parallel to the longitudinal axis A.

14. The adapter as claimed in claim 1, wherein the recess in the form of a blind hole is substantially frustoconical and narrows toward the head area.

15. The adapter as claimed claim 1, wherein the recess in the form of a blind hole has at least one stop surface for transmitting the torque from the adapter to the mounting part, each of the stop surfaces forming, with a corresponding mating surface of the mounting part, a connection that is secure against rotation up to at least the torque T_{deform}.

16. The adapter as claimed in claim 15, wherein the recess in the form of a blind hole has four stop surfaces.

17. The adapter as claimed in claim 1, wherein the adapter is made of metal.

18. The adapter as claimed in claim 17, wherein the inner face of the receiving portion is at least partially coated with a ceramic or with diamond-like carbon.

19. The adapter as claimed in claim 17, wherein the metal is stainless steel.

20. The adapter as claimed in claim 1, wherein T_{deform} is greater than 80 Ncm.

21. The adapter as claimed in claim 1, wherein T_{deform} is greater than 90 Ncm.

22. The adapter as claimed in claim 1, wherein T_{deform} is less than 130 Ncm.

22. The adapter as claimed in claim 1, wherein T_{deform} is less than 110 Ncm.
